(19) United States
(12) Patent Application Publication
(10) Pub. No.: US 2020/0027399 A1
(43) Pub. Date: Jan. 23, 2020

(54) OLED DISPLAY PANEL, OLED DISPLAY DEVICE AND DRIVING METHOD THEREOF

(71) Applicant: Wuhan China Star Optoelectronics Semiconductor Display Technology Co., Ltd., Wuhan (CN)

(72) Inventor: Yan XIE, Shenzhen (CN)

(21) Appl. No.: 16/207,226

(22) Filed: Dec. 3, 2018

Related U.S. Application Data
(63) Continuation of application No. PCT/CN2018/107479, filed on Sep. 26, 2018.

(30) Foreign Application Priority Data
Jul. 18, 2018 (CN) 201810791797.X

(51) Int. Cl. G09G 3/3258

(52) U.S. Cl. CPC G09G 3/3258; G09G 2320/0233; G09G 2300/0809; G09G 2300/0876; G09G 2320/045; G09G 2320/0223

(57) ABSTRACT

The disclosure disclose an OLED display panel, OLED display device and driving method thereof, the OLED display panel includes a first and a second storage capacitor, a light-emitting circuit; the light-emitting circuit includes a first switch and a light-emitting unit; a control terminal of the first switch is coupled to a first terminal of the first storage capacitor, an input terminal of the first switch is coupled to a first terminal of the second storage capacitor and a first power supply, and an output terminal of the first switch is coupled to the light-emitting unit; second terminals of the second storage capacitor and the first storage capacitor are coupled to a second power supply, and the control terminal of the first switch is coupled to a data line through a third switch; control terminals of the second switch and the third switch are coupled to a scan line.

### CROSS REFERENCE TO RELATED APPLICATIONS

The present application is a continuation-application conversion of International (PCT) Patent Application No. PCT/CN2018/107479 filed on Sep. 26, 2018, which claims foreign priority of Chinese Patent Application No. 201810791797.X, filed on Jul. 18, 2018 in the State Intellectual Property Office of China, the contents of all of which are hereby incorporated by reference.

### TECHNICAL FIELD

Embodiments of the present disclosure generally relate to display technology, and in particular relate to an OLED display panel, OLED display device and driving method thereof.

### BACKGROUND

With the characteristics of self-illumination, quick response, wide angle of view, manufacturing on flexible substrates and the like, organic light emitting diodes (OLEDs) have been more and more widely applied to the field of high-performance display.

TFT (Thin Film Transistor) switch circuits in existing OLED panels mostly adopt low-temperature poly-silicon thin-film transistors (LTPS TFT) or oxide thin-film transistors (Oxide TFT). Due to the limitations in crystallization process and manufacturing level, TFT switch circuits manufactured on large-area glass substrates are usually non-uniform in electrical parameters such as the threshold voltage, which results in inconsistent threshold voltage deviations of TFTs, and consequentially, current differences and brightness differences of OLEDs are caused and sensed by human eyes. In addition, the threshold voltage of the TFTs may drift under long-term pressurization and high temperature conditions, which results in different threshold drifts of the TFTs of the panels, and consequentially, differences in display brightness are caused.

On the other hand, under the influence of line trace impedance voltage drop, supply voltages applied to the transistors are also different, which may also cause nonuniformity in brightness, consequentially, affecting the image quality.

### SUMMARY

The technical problem to be solved by the present disclosure is to provide an OLED display panel, OLED display device and driving method thereof, which are used to avoid non-uniform brightness and to improve brightness uniformity by reducing the influences of threshold voltages of switches and line trace impendence voltage drop.

In order to solve the above-mentioned technical problem, a first technical scheme adopted by the present disclosure is: providing an OLED display device, comprising: an OLED display panel, the OLED display panel comprising: a plurality of pixel regions, each pixel region comprising:

a first storage capacitor, a second storage capacitor and a light-emitting circuit; wherein the light-emitting circuit comprises a first switch and a light-emitting unit; a control terminal of the first switch is coupled to a first terminal of the first storage capacitor, an input terminal of the first switch is coupled to a first terminal of the second storage capacitor and a first power supply, and an output terminal of the first switch is coupled to the light-emitting unit; a second terminal of the second storage capacitor and a second terminal of the first storage capacitor are coupled to a second power supply through a second switch, and the control terminal of the first switch is also coupled to a data line through a third switch; a control terminal of the second switch and a control terminal of the third switch are coupled to a scan line;

wherein the second storage capacitor is used to store a threshold voltage of the first switch when the first switch, the second switch and the third switch are turned on, the first power supply is turned off, and when the voltages output by the data line are equal to the voltages of the second power supply; the first storage capacitor is used to store a voltage difference between the second power supply and the data line voltage when the second switch and the third switch are turned on, the first power supply and the first switch are turned off, and voltages output by the data line are changed to the data line voltages; the first storage capacitor and the second storage capacitor are also used to provide a driving voltage for the first switch in the display stage; the first switch is a driver transistor.

In order to solve the above-mentioned technical problem, a second technical scheme adopted by the present disclosure is: providing an OLED display panel, comprising a plurality of pixel regions, each pixel region comprising:

a first storage capacitor, a second storage capacitor and a light-emitting circuit; wherein the light-emitting circuit comprises a first switch and a light-emitting unit; a control terminal of the first switch is coupled to a first terminal of the first storage capacitor, an input terminal of the first switch is coupled to a first terminal of the second storage capacitor and a first power supply, and an output terminal of the first switch is coupled to the light-emitting unit; a second terminal of the second storage capacitor and a second terminal of the first storage capacitor are coupled to a second power supply through a second switch, and the control terminal of the first switch is also coupled to a data line through a third switch; a control terminal of the second switch and a control terminal of the third switch are coupled to a scan line.

In order to solve the above-mentioned technical problem, a third technical scheme adopted by the present disclosure is: providing a driving method of an OLED display device, wherein the OLED display device comprises an OLED display panel, the OLED display panel comprises a plurality of pixel regions, each pixel region comprises:

a first storage capacitor, a second storage capacitor and a light-emitting circuit; wherein the light-emitting circuit comprises a first switch and a light-emitting unit; a control terminal of the first switch is coupled to a first terminal of the first storage capacitor, an input terminal of the first switch is coupled to a first terminal of the second storage capacitor and a first power supply, and an output terminal of the first switch is coupled to the light-emitting unit; a second terminal of the second storage capacitor and a second terminal of the first storage capacitor are coupled to a second power supply through a second switch, and the control terminal of the first switch is also coupled to a data line through a third switch; a control terminal of the second switch and a control terminal of the third switch are coupled to a scan line; the driving method comprises:

in the storage stage, voltage differences between the second power supply and data line voltages are stored by the first storage capacitor, and the threshold voltages of the first switch are stored by the second storage capacitor;

in the display stage, the first switch is driven to be turned on in terms of the voltage differences, stored by the first storage capacitor, between the second power supply and the data line voltage and the threshold voltages, stored by the second storage capacitor, of the first switch.

The present disclosure has the following beneficial effects over the related art: the OLED display panel comprises a first storage capacitor and a second storage capacitor; in the storage stage, on-off of the corresponding switches is controlled in terms of a specific time sequence, so that charges are stored in the first storage capacitor and the second storage capacitor, the first storage capacitor stores the voltage difference between the second power supply and the data line voltage, and the second storage capacitor stores the threshold voltage of the first switch. In the display stage, the first storage capacitor and the second storage capacitor provide a driving voltage for the first switch to compensate for threshold voltages of the first switch and supply voltages applied to the first switch, and accordingly, the influences of the threshold voltages of the switches and line impedance voltage drop are reduced, brightness nonuniformity is avoided, and brightness uniformity is improved.

### BRIEF DESCRIPTION OF THE DRAWINGS

FIG. 1 is a structural view of one embodiment of an OLED display panel of the present disclosure.

FIG. 2 is a structural view of one embodiment of a pixel region of the OLED display panel in FIG. 1.

FIG. 3 is a structural view of one specific embodiment of the pixel region in FIG. 2.

FIG. 4 is a sequential diagram of a scan line Scan, an enable signal line EM and a reset signal line Reset of the pixel region in FIG. 3.

FIG. 5 is an equivalent circuit diagram of the pixel region in FIG. 3 in a second stage t2.

FIG. 6 is an equivalent circuit diagram of the pixel region in FIG. 3 in a third stage t3.

FIG. 7 is an equivalent circuit diagram of the pixel region in FIG. 3 in a fourth stage.

FIG. 8 is a flow diagram of one embodiment of a driving method of the OLED display device of the present disclosure.

### DETAILED DESCRIPTION

The present disclosure provides an OLED display panel, an OLED display device and a driving method of the OLED display device. In order to make the objectives, technical solutions and technical effects of the present disclosure more explicit and clear, the embodiments of the present disclosure are further detailed below. It should be understood that specific embodiments described below are only used to explain the present disclosure and are not intended to limit the present disclosure.

This embodiment of the present disclosure provides an OLED display panel. The OLED display panel may include a plurality of pixel regions. Each pixel region may include a first storage capacitor, a second storage capacitor and a light-emitting circuit. Wherein the light-emitting circuit may include a first switch and a light-emitting unit; a control terminal of the first switch may be coupled to a first terminal of the first storage capacitor, an input terminal of the first switch may be coupled to a first terminal of the second storage capacitor and a first power supply, and an output terminal of the first switch may be coupled to the light-emitting unit; a second terminal of the second storage capacitor and a second terminal of the first storage capacitor may be coupled to a second power supply through a second switch, and the control terminal of the first switch may be also coupled to a data line through a third switch; a control terminal of the second switch and a control terminal of the third switch may be coupled to a scan line. In the storage stage, the first storage capacitor may be used to store a voltage difference between the second power supply and the data line, and the second storage capacitor may be used to store a threshold voltage of the first switch. The first storage capacitor and the second storage capacitor may also be used to provide a driving voltage for the first switch in the display stage.

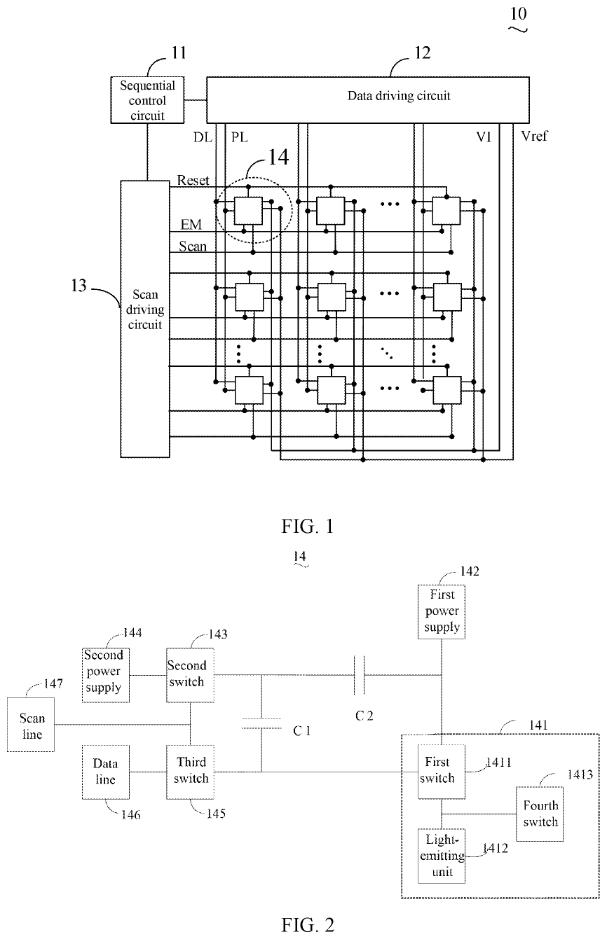

In order to make the above-mentioned embodiments of the OLED display panel clear, please referring to FIG. 1 and FIG. 2, FIG. 1 is a structural view of one embodiment of an OLED display panel of the present disclosure; FIG. 2 is a structural view of one embodiment of a pixel region of the OLED display panel in FIG. 1.

Referring to FIG. 1, the OLED display panel 10 in this embodiment may include a sequential control circuit 11, a data driving circuit 12 and a scan driving circuit 13. Wherein the sequential control circuit 11 may be coupled to the data driving circuit 12 and the scan driving circuit 13.

The OLED display panel 10 may further include a plurality of parallel scan lines and a plurality of data lines perpendicular to the plurality of scan lines, so that a plurality of pixel regions 14 are formed. Wherein, the line arrangement mode that the plurality of scan lines are perpendicular to the plurality of data lines is only an illustrative one, and it should be understood that in other embodiments, the plurality of scan lines may not be perpendicular to the plurality of data lines.

Wherein the sequential control circuit 11 may be used to generate sequential control instructions and to output the corresponding sequential control instructions to the data driving circuit 12 and the scan driving circuit 13. The scan driving circuit 13 controls the corresponding plurality of scan lines to output sequential level signals. The data driving circuit 12 controls the corresponding plurality of data lines to output voltage signals. Wherein each of the plurality of the scan lines may include a scan line Scan, an enable signal line EM and a reset signal line Reset. Each of the plurality of the data lines may include a first power supply PL, a second power supply Vref, a third power supply VI and a data line DL.

In this embodiment, the plurality of scan lines and the plurality of data lines may be coupled to the plurality of pixel regions 14 so as to provide corresponding power supply signals and control signals to drive light-emitting units (not shown) of the pixel regions 14 to perform display, and thus, the display function of the display panel 10 is fulfilled.

The structure of the plurality of pixel regions 14 in this embodiment is illustrated below with one pixel region 14 as an example, with reference to FIG. 2.

The pixel region 14 may include a first storage capacitor C1, a second storage capacitor C2 and a light-emitting circuit 141, wherein the light-emitting circuit 141 may include a first switch 1411 and a light-emitting unit 1412. A control terminal of the first switch 1411 may be coupled to a first terminal of the first storage capacitor C1, and an input terminal of the first switch 1411 may be coupled to a first terminal of the second storage capacitor C2 and a first power supply 142. In one embodiment, the pixel region 14 may further include a fifth switch (not shown), wherein a control terminal of the fifth switch may be coupled to the corresponding enable signal line (not shown) of the OLED panel, an input terminal of the fifth switch may be coupled to the first power supply 142, and an output terminal of the fifth switch may be coupled to the input terminal of the first switch 1411; and when the fifth switch is turned on, the first power supply 142 supplies power to the first switch 1411.

Particularly, an output terminal of the first switch 1411 may be coupled to the light-emitting unit 1412, wherein the light-emitting unit 1412 may be an OLED. A second terminal of the second storage capacitor C2 and a second terminal of the first storage capacitor C1 may be coupled to a second power supply 144 through a second switch 143, and the control terminal of the first switch 1411 may be also coupled to a data line 146 through a third switch 145. Meanwhile, a control terminal of the second switch 143 and a control terminal of the third switch 145 may be coupled to a scan line 147. Wherein the scan line 147 outputs a corresponding voltage according to a sequential control instruction so as to control on-off of the second switch 143 and the third switch 145. The data line 146 outputs a voltage according to a sequential control instruction, and the voltage output by the data line 146 varies when the display panel is in different stages. When the third switch 145 is turned on, the corresponding voltage output by the data line 146 may be applied to the control terminal of the first switch 1411. Please refer to the subsequent description for the operating principle of the pixel region 14.

Referring to in FIG. 1 and FIG. 2 in combination, in this embodiment, the first power supply 142, the second power supply 144 and the data line 146 may be all coupled to the data driving circuit 12 of the display panel 10, which means that corresponding voltage signals to the first power supply 142 and the second power supply 144 may be generated or provided by the data driving circuit 12, and the voltage output by the data line 146 may be also generated or provided by the data driving circuit 12.

In this embodiment, the first storage capacitor C1 is used to store the voltage difference between the second power supply 144 and the data line 146 voltage in the storage stage, and the second storage capacitor C2 is used to store the threshold voltage of the first switch 1411. The first storage capacitor C1 and the second storage capacitor C2 are also used to provide a driving voltage for the first switch 1411 to compensate for threshold voltages of the first switch 1411 and supply voltages applied to the first switch 1411 in the display stage. And accordingly, the influences of the threshold voltages of the switches and line impedance voltage drop are reduced, brightness nonuniformity is avoided, and brightness uniformity is improved.

In another embodiment, as the first switch 1411 will be turned on in the reset stage and the storage stage, the light-emitting circuit 141 may further include a fourth switch 1413 used to prevent the light-emitting unit 1412 from emitting light. Wherein the fourth switch 1413 may be coupled to the output terminal of the first switch 1411 and may be used to divert the light-emitting circuit 141 in the reset stage and the storage stage so as to prevent the light-emitting unit 1412 from emitting light in the reset stage and the storage stage. Particularly, an input terminal of the fourth switch 1413 may be coupled to the output terminal of the first switch 1411, an output terminal of the fourth switch 1413 may be grounded or may be externally coupled to a negative voltage, and a control terminal of the fourth switch 1413 may be coupled to the corresponding reset signal line (not shown) of the OLED display panel.

Wherein the first switch 1411, the second switch 143, the third switch 145, the fourth switch 1413 and the fifth switch may all be thin-film transistors. According to actual conditions, the first switch 1411, the second switch 143, the third switch 145, the fourth switch 1413 and the fifth switch may be designed as P-type thin-film transistors or N-type thin-film transistors as long as the type of the transistors corresponds to sequential control signals, and there is no specific limitation in this regard. It should be understood that the first switch 1411, the second switch 143, the third switch 145, the fourth switch 1413 and the fifth switch can also be switches of other types, such as triodes.

In this embodiment, the first switch 1411 may be a driver transistor, which may be used to preset storage voltages of the first storage capacitor C1 and the second storage capacitor C2 and may be also used to drive the light-emitting unit 1412 to emit light. Particularly, in the storage stage, the storage voltages of the first storage capacitor C1 and the second storage capacitor C2 may be set by controlling on-off of the driver transistor, wherein the first storage capacitor C1 may be used to store a voltage different between the second power supply Vref and a data line voltage Vdata, and the second storage capacitor C2 may be used to store a threshold voltage Vₜₕ of the driver transistor. In the display stage, the first storage capacitor C1 and the second storage capacitor C2 provide a gate-source voltage for the driver transistor so as to turn on the driver transistor, so that it is ensured that the light-emitting current of the light-emitting unit 1412 is independent of the threshold voltage of the driver transistor and the supply voltage output by the first power supply 142, and accordingly, the uniformity of the display panel is ensured. Please refer to the subsequent analysis process for the specific operating process of the driver transistor.

To clearly explain the structure and operating principle of the pixel region 14 in this embodiment of the present disclosure, a description is given below with the first switch 1411, the second switch 143, the third switch 145, the fourth switch 1413 and the fifth switch as P-type thin-film transistors and the light-emitting unit 1412 as an OLED.

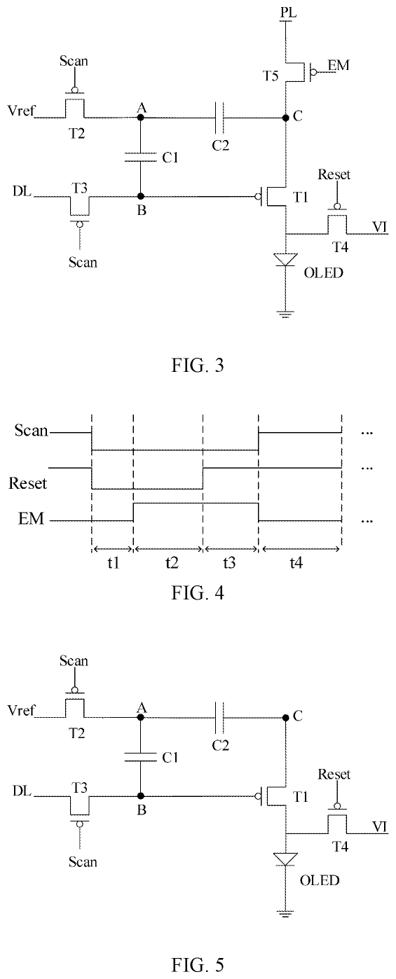

Please refer to FIG. 3 which is a structural view of a specific embodiment of the pixel region in FIG. 2.

In this embodiment, the pixel region in this embodiment include a first transistor T1, a second transistor T2, a third transistor T3, a fourth transistor T4, a fifth transistor T5, a first storage capacitor C1, a second storage capacitor C2 and an OLED.

Wherein a gate of the second transistor T2 and a gate of the third transistor T3 may be coupled to a scan line Scan, a first electrode of the second transistor T2 may be coupled to a second power supply Vref, and a second electrode of the second transistor T2 may be coupled to a second terminal of the first storage capacitor C1 and a second terminal of the second storage capacitor C2.

A first electrode of the third transistor T3 may be coupled to a data line DL, a second electrode of the third transistor T3 may be coupled to a first terminal of the first storage capacitor C1 and a gate of the first transistor T1.

A gate of the fifth transistor T5 may be coupled to an enable signal line EM, a first electrode of the fifth transistor T5 may be coupled to a first power supply PL, and a second electrode of the fifth transistor T5 may be coupled to a first terminal of the second storage capacitor C2 and a first electrode of the first transistor T1. A second electrode of the first capacitor T1 may be coupled to a first terminal of the OLED, and a second terminal of the OLED may be grounded.

The second electrode of the first transistor T1 may be also coupled to a first electrode of the fourth transistor T4, a second electrode of the fourth transistor T4 may be coupled to a third power supply VI, and a gate of the fourth transistor T4 may be coupled to a reset signal line Reset.

In one embodiment, the first electrode may be the source of the corresponding transistor, and the second electrode may be the drain of the corresponding transistor.

With reference to FIG. 1, that needs to be pointed out is that the scan line Scan, the enable signal line EM and the reset signal line Reset may be correspondingly coupled to the scan driving circuit 13, and that the first power supply PL, the second power supply Vref, the third power supply VI and the data line DL may be correspondingly coupled with the data driving circuit 13.

Wherein the voltage of the second power supply Vref may be designed in terms of parameters of the second transistor T2, the third power supply VI may be a negative voltage such as −2V, and the voltage of the first power supply PL may be designed in terms of parameters of the first transistor T1. The voltages of the second power supply Vref, the first power supply PL and the third power supply VI may be constant, while the corresponding voltage of the data line DL may be variable and may be determined in terms of a control instruction from the sequential control circuit 11.

Wherein on-off the corresponding transistors may be controlled in terms of sequential levels of the scan line Scan, the enable signal line EM and the reset signal line Reset so as to realize display of the OLED.

The operating principle of the pixel region is explained below with reference to FIG. 3 and FIG. 4, wherein FIG. 4 is a sequential diagram of the scan line Scan, the enable signal line EM and the reset signal line Reset in FIG. 3.

As shown in FIG. 4, the sequential diagram involves four stages, wherein the first stage t1 is a reset stage, the second stage t2 and the third stage t3 are a storage stage, and the fourth stage t4 is a display stage.

In the first stage t1, the scan line Scan, the reset signal line Reset and the enable signal line EM output low levels. In the second stage t2, the scan line Scan and the reset signal line Reset output low levels, and the enable signal line EM outputs a high level. In the third stage t3, the scan line Scan outputs a low level, the reset signal line Reset and the enable signal line EM output high level. And in the fourth stage t4, the scan line Scan and the reset signal line Reset output high levels, and the enable signal line EM outputs a low level. On-off of the corresponding transistors is controlled in terms of level signals output by the scan line Scan, the enable signal line EM and the reset signal line Reset output in each stage.

Furthermore, referring to FIG. 3, when the pixel region is in different stages, the potentials of point A, point B and point C in the figure will vary accordingly, so that a voltage difference between the second power supply Vref and the voltage of the data line DL is stored by the first storage capacitor C1, and the threshold voltage of the first transistor T1 is stored by the second storage capacitor C2. The first storage capacitor C1 and the second storage capacitor C2 provide a driving voltage for the first transistor T1 in the display stage, so that the OLED is made to emit light.

The operating principle of the pixel region is explained below stage by stage.

In the first stage t1 (reset stage), the second transistor T2, the third transistor T3, the fourth transistor T4 and the fifth transistor T5 may be turned on.

In the first stage t1, a voltage output by the data line DL may be equal to the voltage of the second power supply Vref. In the first stage t1, the potentials of point A and point B may be equal to the second power supply Vref, and the potential of point C may be equal to the first power supply PL.

In the second stage t2 (storage stage), the second transistor T2, the third transistor T3 and the fourth transistor T4 may be turned on, while the fifth transistor T5 may be turned off. Please refer to FIG. 5 which is an equivalent circuit diagram of the pixel region in FIG. 3 in the second stage t2.

In the second stage t2, the voltage output by the data line DL may be equal to the voltage of the second power supply Vref. At the beginning of the second stage t2, the first electrode of the first transistor t1 may be in a floating state, the potential of point C may be equal to the first power supply PL, and the potential of point B may be equal to the second power supply Vref; as the voltage difference between the first power supply PL and the second power supply Vref may be greater than the threshold voltage Vₜₕ of the first transistor T1, the second storage capacitor C2 discharges at this moment to turn on the first transistor T1, the first transistor T1 drains via the source till the potential difference between point B and point C is equal to the threshold voltage Vₜₕ of the first transistor T1, and then the first transistor T1 is turned off. In the stage where the first transistor T1 is turned on, the OLED may emit light; in order to prevent the OLED from emitting light without permission, the fourth transistor T4 is turned on in the second stage t2, and the second electrode of the fourth transistor T4 is coupled to the negative voltage VI for diversion so as to prevent the OLED from emitting light without permission. In another embodiment, the second electrode of the fourth transistor T4 may also be grounded.

What needs to be pointed out herein is that: it is in a critical state that the potential difference between point B and point C is equal to the threshold voltage Vₜₕ of the first transistor T1, but in an actual process, there may be an error within a certain range. When the first transistor T1 is turned off, the potential of point C is equal to Vref+|Vₜₕ|, the potential of point A is equal to the second power supply Vref, and thus, the second storage capacitor C2 stores the voltage difference between the potential of point C and the potential of point A, that is to say, the second storage capacitor C2 stores the threshold voltage Vₜₕ of the first transistor T1.

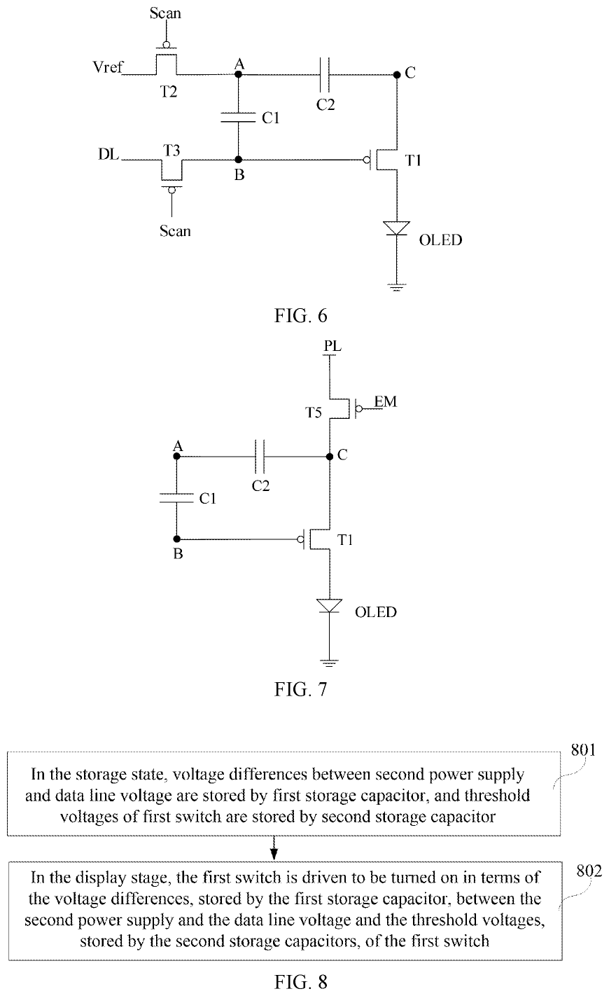

In the third stage t3 (storage stage), the second transistor T2 and the third transistor T3 are turned on, the fourth transistor T4 and the fifth transistor T5 are turned off. Please refer to FIG. 6 which is an equivalent circuit diagram of the pixel region in FIG. 3 in the third stage.

In the third stage t3, the voltage output by the data line DL is changed to the data line voltage Vdata, wherein the data line voltage Vdata corresponds to the grayscale voltage of the OLED and is specifically determined in terms of the display brightness of the OLED.

In this case, the second power supply Vref has a corresponding voltage Vref, the potential of point A is equal to the voltage Vref of the second power supply, the potential of point C is equal to Vref+|Vₜₕ|, the potential of point B is equal to the data line voltage Vdata, at this moment, the first transistor T1 is turned off, and the first storage capacitor C1 stores a voltage difference between the potential of point A and the potential of point B, that is to say, the first storage capacitor C1 stores a voltage difference between the voltage Vref of the second power supply Vref and the data line voltage Vdata, wherein the voltage stored in the first storage capacitor C1 is Vref−Vdata.

The fourth stage t4 begins after the corresponding voltages are stored in the first storage capacitor C1 and the second storage capacitor C2. In the fourth stage t4, the second transistor T2, the third transistor T3 and the fourth transistor T4 are turned off, while the fifth transistor T5 is turned on. Please refer to FIG. 7 which is an equivalent circuit diagram of the pixel region in FIG. 3 in the fourth stage t4.

In the fourth stage t4 (display stage), the fifth transistor T5 is turned on, the first power supply PL outputs a voltage VDD, at this moment, the potential of point C changes accordingly, the potentials of point A and point B also change accordingly, point B is correspondingly connected to the gate of the first transistor T1, point C is correspondingly connected to the source of the first transistor T1, and thus, the gate-source voltage of the first transistor T1 is the voltage stored in the first storage capacitor C1 and the second storage capacitor C2, namely V_{gs}=V_{ref}−V_{data}+|Vh|.

The current I_{OLED} across the OLED is calculated according to the following current calculation formula 1 for the OLED:

$${I}_{OLED} = \frac{1}{2} μ {C}_{ox} \frac{W}{L} {( {V}_{gs} - \vert {V}_{th} \vert )}^{2} \qquad Formula 1$$

Wherein, μ is the carrier mobility, Cₒₓ is gate oxide capacitance,

$$\frac{W}{L}$$

is the width-to-length ratio of the transistors, and Vₜₕ is the threshold voltage of the transistors. In the related art, different pixel regions have different threshold voltages Vₜₕ, and the threshold voltage Vₜₕ of each pixel region may drift over time, so that differences in display brightness and nonuniformity of display brightness are caused.

According to the present disclosure, the threshold voltage Vₜₕ of the transistors is captured in advance and is stored in the corresponding storage capacitor, so that the influences of the threshold voltage Vₜₕ are effective eliminated. Particularly, V_{gs}=V_{ref}−V_{data}−|Vₜₕ| is substituted into formula 1 to obtain

$${I}_{OLED} = \frac{1}{2} μ {C}_{ox} \frac{W}{L} {( {V}_{ref} - {V}_{data} )}^{2} ,$$

wherein V_{data} is the data line voltage output by the data line DL, and V_{ref} is the reference voltage output by the second power supply Vref. In order to more visually represent the current I_{OLED} of the OLED,

$$K = μ {C}_{ox} \frac{W}{L}$$

is set, and then I_{OLED}=½K(V_{ref}−V_{data})², wherein K is the current amplification factor of the transistors.

From the above deduction, the current used to drive the OLED to emit light is independent of the threshold voltage Vₜₕ of the first transistor T1 and the output voltage VDD of the first power supply PL and is dependent on the reference voltage output by the second power supply Vref and the data line voltage output by the data line DL, and thus, the influence of threshold voltage nonuniformity of the transistors on display is eliminated.

The multiple transistors and capacitors are used to control on-off and charging/discharging of the circuit so that the gate-source voltage between the gate and the source of the first transistor T1 can be kept unchanged by the storage capacitors, accordingly, the current across the first transistor T1 is independent of the threshold voltage of the first transistor T1, a current difference, caused by inconsistency or deviation of the threshold voltage of the first transistor T1, of the OLED is compensated, the uniformity of the illumination brightness of a display device is improved, and the display effect is remarkably improved. Meanwhile, the influence of line impendence voltage drop of the output voltage VDD of the first power supply PL is eliminated.

Different from the related art, the OLED display panel in this embodiment may include the first storage capacitor and the second storage capacitor; in the storage stage, on-off of the corresponding switches is controlled in terms of a specific time sequence, so that charges are stored in the first storage capacitor and the second storage capacitor, the first storage capacitor stores the voltage difference between the second power supply and the data line voltage, and the second storage capacitor stores the threshold voltage of the first switch. In the display stage, the first storage capacitor and the second storage capacitor provide a driving voltage for the first switch to compensate for threshold voltages of the first switch and supply voltages applied to the first switch, and accordingly, the influences of the threshold voltages of the switch and line impedance voltage drop are reduced, brightness nonuniformity is avoided, and brightness uniformity is improved.

The present disclosure further provides an OLED display device. The OLED display device may include the OLED display panel in any one of the embodiments mentioned above.

In one embodiment, the OLED display device may be a television or a smartphone, and may also be electronic newspaper or the like.

Please refer to FIGS. 1-7 and relevant text description for the structure and operating principle of the OLED display device. Unnecessary details will no longer be given herein.

Referring to FIG. 8 which is a flow diagram of one embodiment of a driving method of the OLED display device of the present disclosure.

The OLED display device may include the OLED display panel in any one of the embodiments mentioned above. Specifically, the OLED display panel may include a plurality of pixel regions. Each pixel region may include a first storage capacitor, a second storage capacitor and a light-emitting circuit. Wherein the light-emitting circuit may include a first switch and a light-emitting unit; a control terminal of the first switch may be coupled to a first terminal of the first storage capacitor, an input terminal of the first switch may be coupled to a first terminal of the second storage capacitor and a first power supply, and an output terminal of the first switch may be coupled to the light-emitting unit; a second terminal of the second storage capacitor and a second terminal of the first storage capacitor may be coupled to a second power supply through a second switch, and the control terminal of the first switch may be also coupled to a data line through a third switch; a control terminal of the second switch and a control terminal of the third switch may be coupled to a scan line.

In one embodiment, the OLED display panel may further include a fifth switch, wherein a control terminal of the fifth switch may be coupled to the corresponding enable signal line of the OLED panel, an input terminal of the fifth switch may be coupled to the first power supply, and an output terminal of the fifth switch may be coupled to the input terminal of the first switch; and when the fifth switch is turned on, the first power supply supplies power to the first switch.

In one embodiment, the light-emitting circuit may further include a fourth switch used to prevent the light-emitting unit from emitting light. Wherein the fourth switch may be coupled to the output terminal of the first switch and may be used to divert the light-emitting circuit in the storage stage so as to prevent the light-emitting unit from emitting light. Particularly, an input terminal of the fourth switch may be coupled to the output terminal of the first switch, an output terminal of the fourth switch may be grounded or may be externally coupled to a negative voltage, and a control terminal of the fourth switch may be coupled to the corresponding reset signal line of the OLED display panel.

Please refer to FIGS. 1-7 and relevant text description for the structure and operating principle of the OLED display panel. Unnecessary details will no longer be given herein.

A driving method of the OLED display device in this embodiment may include the following blocks:

801: in the storage stage, voltage differences between the second power supply and data line voltage are stored by the first storage capacitor, and the threshold voltages of the first switch are stored by the second storage capacitor.

In this embodiment, the OLED display device presets a sequential control signal to control on-off of the corresponding switches, and the display function of the OLED display device is realized mainly through four stages.

First, in the first stage, the OLED display device turns on the first switch, the second switch and the third switch, a first electrode of the first switch is coupled to the first power supply, and after the voltages output by the data lines are regulated to be equal to the voltages of the second power supply, voltages of two terminals of the first storage capacitor and the second storage capacitor are preset.

Afterwards, the second stage begins, the OLED display device turns on the first switch, the second switch and the third switch first and then turns off the first power supply, and after the voltages output by the data line are regulated to be equal to the voltages of the second power supply, the threshold voltages of the first switch are acquired and stored by the second storage capacitor.

Furthermore, the third stage begins, the OLED display device turns off the first switch, the voltages output by the data line are changed to the data line voltage, and the voltage differences between the second power supply and the data line voltage are stored by the first storage capacitor.

802: in the display stage, the first switch is driven to be turned on in terms of the voltage differences, stored by the first storage capacitor, between the second power supply and the data line voltage and the threshold voltages, stored by the second storage capacitor, of the first switch.

In this embodiment, after voltage storage is completed, the fourth stage (namely the display stage) begins, the OLED display device turns on the first switch and turns off the second switch and the third switch, and the first switch is driven to be turned on in terms of the voltage differences, stored by the first storage capacitor, between the second power supply and the data line voltage and the threshold voltages, stored by the second storage capacitor, of the first switch.

The structure and driving method of the OLED device in this embodiment respectively correspond to the structure and operating principle of the OLED display panel in the above embodiments. Please refer to FIGS. 1-7 and relevant text description for a detailed process of the driving method. Unnecessary details will no longer be given herein.

Different from the related art, the OLED display panel of the present disclosure includes a first storage capacitor and a second storage capacitor; in the storage stage, on-off of the corresponding switches is controlled in terms of a specific time sequence, so that charges are stored in the first storage capacitor and the second storage capacitor, the first storage capacitor stores the voltage difference between the second power supply and the data line voltage, and the second storage capacitor stores the threshold voltage of the first switch. In the display stage, the first storage capacitor and the second storage capacitor provide a driving voltage for the first switch to compensate for threshold voltages of the first switch and supply voltages applied to the first switch, and accordingly, the influences of the threshold voltages of the switch and line impedance voltage drop are reduced, brightness nonuniformity is avoided, and brightness uniformity is improved.

It should be understood that the method and device disclosed in the several embodiments of this application can also be realized in other ways. The device embodiments described above are only illustrative ones, for instance, partition of modules or units is only based on the logic function, but in actual implementations, partition can also be conducted in other ways, for instance, multiple units or assemblies can be combined or integrated into another system, or certain characteristics can be omitted or not be implemented. In addition, coupling, direct coupling or communication connection mentioned or discussed above can be realized via certain interfaces, and indirect coupling or communication connection between devices or units can be realized electrically, mechanically or in other forms.

Units described as separated components may be or may not be physically separated, and components displayed as units may be or may not be physical units and can be located at the same position or be distributed on multiple network units. Part or all of the units can be adopted to fulfill the objectives of the solutions of this embodiment according to actual requirements.

Besides, all functional units in the embodiments of this application can be integrated into one processing unit or can be physically independent of one another, or two or more units can be integrated into one unit. The aforesaid integrated units can be realized in a form of hardware or can be realized in a form of software function units. If the integrated units are realized in the form of software function units and are sold or used as independent products, these integrated units can be stored in a computer-readable storage medium.

Based on the above appreciation, the essential parts or the parts, making contributions to the prior art, of the technical solutions or part or all of the technical solutions of this application can be embodied in the form of software products, and these computer software products are stored in a storage medium which includes a plurality of instructions, so that all or part of the steps of the method in all embodiments of this application can be executed by one piece of computer equipment (such as personal computer, server or network equipment) or one processor. The storage medium mentioned above can be any one selected from various media capable of storing program codes, such as a USB flash disk, a mobile hard disk drive, a read-only memory (ROM), a random access memory (RAM), a disk and a CD.

The foregoing is merely embodiments of the present disclosure, and is not intended to limit the scope of the present disclosure. Any equivalent structure or flow transformation made based on the specification and the accompanying drawings of the present disclosure, or any direct or indirect applications of the disclosure on other related fields, shall all be covered within the protection of the present disclosure.

What is claimed is:

1. An OLED display device, comprising: an OLED display panel, the OLED display panel comprising: a plurality of pixel regions, each pixel region comprising:
a first storage capacitor, a second storage capacitor and a light-emitting circuit; wherein the light-emitting circuit comprises a first switch and a light-emitting unit; a control terminal of the first switch is coupled to a first terminal of the first storage capacitor, an input terminal of the first switch is coupled to a first terminal of the second storage capacitor and a first power supply, and an output terminal of the first switch is coupled to the light-emitting unit; a second terminal of the second storage capacitor and a second terminal of the first storage capacitor are coupled to a second power supply through a second switch, and the control terminal of the first switch is also coupled to a data line through a third switch; a control terminal of the second switch and a control terminal of the third switch are coupled to a scan line;
wherein the second storage capacitor is used to store a threshold voltage of the first switch when the first switch, the second switch and the third switch are turned on, the first power supply is turned off, and when the voltages output by the data line are equal to the voltages of the second power supply; the first storage capacitor is used to store a voltage difference between the second power supply and the data line voltage when the second switch and the third switch are turned on, the first power supply and the first switch are turned off, and voltages output by the data line are changed to the data line voltages; the first storage capacitor and the second storage capacitor are also used to provide a driving voltage for the first switch in the display stage; the first switch is a driver transistor.

2. The OLED display device according to claim 1, wherein the light-emitting circuit comprises a fourth switch, the fourth switch is coupled to the output terminal of the first switch and is used to divert the light-emitting circuit in the storage stage.

3. The OLED display device according to claim 2, wherein an input terminal of the fourth switch is coupled to the output terminal of the first switch, an output terminal of the fourth switch is grounded or is externally coupled to a negative voltage, a control terminal of the fourth switch is coupled to the reset signal line of the OLED display panel.

4. The OLED display device according to claim 3, further comprising a fifth switch, wherein a control terminal of the fifth switch is coupled to the enable signal line of the OLED panel, an input terminal of the fifth switch is coupled to the first power supply, and an output terminal of the fifth switch is coupled to the input terminal of the first switch.

5. The OLED display device according to claim 3, wherein the first switch, the second switch, the third switch and the fourth switch are designed as P-type thin-film transistors.

6. An OLED display panel, comprising a plurality of pixel regions, each pixel region comprising:
a first storage capacitor, a second storage capacitor and a light-emitting circuit; wherein the light-emitting circuit comprises a first switch and a light-emitting unit; a control terminal of the first switch is coupled to a first terminal of the first storage capacitor, an input terminal of the first switch is coupled to a first terminal of the second storage capacitor and a first power supply, and an output terminal of the first switch is coupled to the light-emitting unit; a second terminal of the second storage capacitor and a second terminal of the first storage capacitor are coupled to a second power supply through a second switch, and the control terminal of the first switch is also coupled to a data line through a third switch; a control terminal of the second switch and a control terminal of the third switch are coupled to a scan line.

7. The OLED display panel according to claim 6, wherein the light-emitting circuit comprises a fourth switch, the fourth switch is coupled to the output terminal of the first switch and is used to divert the light-emitting circuit in the storage stage.

8. The OLED display panel according to claim 7, wherein an input terminal of the fourth switch is coupled to the output terminal of the first switch, an output terminal of the fourth switch is grounded or is externally coupled to a negative voltage, a control terminal of the fourth switch is coupled to the reset signal line of the OLED display panel.

9. The OLED display panel according to claim 6, wherein the second storage capacitor is used to store a threshold voltage of the first switch when the first switch, the second switch and the third switch are turned on, the first power supply is turned off, and when the voltages output by the data line are equal to the voltages of the second power supply;
the first storage capacitor is used to store a voltage difference between the second power supply and the data line voltage when the second switch and the third switch are turned on, the first power supply and the first switch are turned off, and voltages output by the data line are changed to the data line voltages;
the first storage capacitor and the second storage capacitor are also used to provide a driving voltage for the first switch in the display stage.

10. The OLED display panel according to claim 7, wherein the second storage capacitor is used to store a threshold voltage of the first switch when the first switch, the second switch and the third switch are turned on, the first power supply is turned off, and when the voltages output by the data line are equal to the voltages of the second power supply;
the first storage capacitor is used to store a voltage difference between the second power supply and the data line voltage when the second switch and the third switch are turned on, the first power supply and the first switch are turned off, and voltages output by the data line are changed to the data line voltages;
the first storage capacitor and the second storage capacitor are also used to provide a driving voltage for the first switch in the display stage.

11. The OLED display panel according to claim 8, wherein the second storage capacitor is used to store a threshold voltage of the first switch when the first switch, the second switch and the third switch are turned on, the first power supply is turned off, and when the voltages output by the data line are equal to the voltages of the second power supply;
the first storage capacitor is used to store a voltage difference between the second power supply and the data line voltage when the second switch and the third switch are turned on, the first power supply and the first switch are turned off, and voltages output by the data line are changed to the data line voltages;
the first storage capacitor and the second storage capacitor are also used to provide a driving voltage for the first switch in the display stage.

12. The OLED display panel according to claim 7, further comprising a fifth switch, wherein a control terminal of the fifth switch is coupled to the enable signal line of the OLED panel, an input terminal of the fifth switch is coupled to the first power supply, and an output terminal of the fifth switch is coupled to the input terminal of the first switch.

13. The OLED display panel according to claim 8, further comprising a fifth switch, wherein a control terminal of the fifth switch is coupled to the enable signal line of the OLED panel, an input terminal of the fifth switch is coupled to the first power supply, and an output terminal of the fifth switch is coupled to the input terminal of the first switch.

14. The OLED display panel according to claim 8, wherein the first switch, the second switch, the third switch and the fourth switch are designed as P-type thin-film transistors.

15. The OLED display panel according to claim 7, wherein the first switch is a driver transistor.

16. The OLED display panel according to claim 8, wherein the first switch is a driver transistor.

17. A driving method of an OLED display device, wherein the OLED display device comprises an OLED display panel, the OLED display panel comprises a plurality of pixel regions, each pixel region comprises:
a first storage capacitor, a second storage capacitor and a light-emitting circuit; wherein the light-emitting circuit comprises a first switch and a light-emitting unit; a control terminal of the first switch is coupled to a first terminal of the first storage capacitor, an input terminal of the first switch is coupled to a first terminal of the second storage capacitor and a first power supply, and an output terminal of the first switch is coupled to the light-emitting unit; a second terminal of the second storage capacitor and a second terminal of the first storage capacitor are coupled to a second power supply through a second switch, and the control terminal of the first switch is also coupled to a data line through a third switch; a control terminal of the second switch and a control terminal of the third switch are coupled to a scan line; the driving method comprises:
in the storage stage, voltage differences between the second power supply and data line voltages are stored by the first storage capacitor, and the threshold voltages of the first switch are stored by the second storage capacitor;
in the display stage, the first switch is driven to be turned on in terms of the voltage differences, stored by the first storage capacitor, between the second power supply and the data line voltage and the threshold voltages, stored by the second storage capacitor, of the first switch.

18. The driving method according to claim 17, wherein in the storage stage, voltage differences between the second power supply and data line voltages are stored by the first storage capacitor, and the threshold voltages of the first switch are stored by the second storage capacitor comprises:
turns on the first switch, the second switch and the third switch first and then turns off the first power supply, and after the voltages output by the data line are regulated to be equal to the voltages of the second power supply, the threshold voltages of the first switch are acquired and stored by the second storage capacitor;
turns off the first switch, the voltages output by the data line are changed to the data line voltages, and the voltage differences between the second power supply and the data line voltage are stored by the first storage capacitor.

19. The driving method according to claim 17, wherein in the display stage, the first switch is driven to be turned on in terms of the voltage differences, stored by the first storage capacitor, between the second power supply and the data line voltage and the threshold voltages, stored by the second storage capacitor, of the first switch comprises:
turns on the first switch and turns off the second switch and the third switch, and the first switch is driven to be turned on in terms of the voltage differences, stored by the first storage capacitor, between the second power supply and the data line voltage and the threshold voltages, stored by the second storage capacitor, of the first switch.

20. The driving method according to claim 18, wherein in the display stage, the first switch is driven to be turned on in terms of the voltage differences, stored by the first storage capacitor, between the second power supply and the data line voltage and the threshold voltages, stored by the second storage capacitor, of the first switch comprises:
turns on the first switch and turns off the second switch and the third switch, and the first switch is driven to be turned on in terms of the voltage differences, stored by the first storage capacitor, between the second power supply and the data line voltage and the threshold voltages, stored by the second storage capacitor, of the first switch.
